(19) United States
(12) Patent Application Publication
(10) Pub. No.: US 2024/0265311 A1
(43) Pub. Date: Aug. 8, 2024

(54) MACHINE LEARNING MODEL TRAINING METHOD AND APPARATUS

(71) Applicant: HUAWEI TECHNOLOGIES CO., LTD., Shenzhen (CN)

(72) Inventors: Jinke REN, Shenzhen (CN); Rong LI, Boulogne Billancourt (FR); Jian WANG, Hangzhou (CN); Gongzheng ZHANG, Hangzhou (CN)

(21) Appl. No.: 18/641,091

(22) Filed: Apr. 19, 2024

Related U.S. Application Data
(63) Continuation of application No. PCT/CN2022/121049, filed on Sep. 23, 2022.

(30) Foreign Application Priority Data
Oct. 22, 2021 (CN) 202111233659.8

(51) Int. Cl. G06N 20/00

(52) U.S. Cl. CPC G06N 20/00

(57) ABSTRACT

This application provides a machine learning model training method and apparatus. One example method includes: A distributed node sends a first parameter set to a central node. The first parameter set is used to determine a target training method for a machine learning model of the distributed node, and the target training method includes a first training method or a second training method. The central node receives the first parameter set from the distributed node, and determines the target training method for the distributed node based on the first parameter set. The central node sends a first message to the distributed node. The first message includes information about the target training method. The distributed node receives the first message from the central node.

### CROSS-REFERENCE TO RELATED APPLICATIONS

This application is a continuation of International Application No. PCT/CN2022/121049, filed on Sep. 23, 2022, which claims priority to Chinese Patent Application No. 202111233659.8, filed on Oct. 22, 2021. The disclosures of the aforementioned applications are hereby incorporated by reference in their entireties.

### TECHNICAL FIELD

This application relates to the communication field, and more specifically, to a machine learning model training method and apparatus.

### BACKGROUND

With advent of a big data era, each device generates massive raw data in various forms every day. The data is generated in a form of an “island” and exists in every corner of the world. Currently, how to design a machine learning framework while meeting data privacy, security, and regulatory requirements to enable an artificial intelligence (artificial intelligence, AI) system to jointly use data of devices more efficiently and accurately becomes an important issue in current development of artificial intelligence.

To fully use data samples of a plurality of terminal devices (distributed nodes) for training, there are currently two typical training architectures: (1) Centralized learning (centralized learning, CL): A plurality of distributed nodes directly upload collected raw data samples to a central node, and the central node performs centralized training. (2) Federated learning (federated learning, FL): A plurality of distributed nodes perform model training by using an existing machine learning model and a local data sample, and then upload a parameter or parameter gradient of an updated local model to a central node. Then, the central node aggregates models or gradients, and delivers an updated global model or gradient to each distributed node. The foregoing steps are repeatedly performed until the model converges.

A breakthrough is made in machine learning in a plurality of fields such as computer vision, natural language processing, and wireless communication. However, as complexity of a machine learning algorithm continuously increases, training of many models such as a GPT-3 model consumes a large amount of energy, resulting in huge environmental costs such as emission (carbon footprint) of greenhouse gases such as carbon dioxide and methane. From 2012 to 2018, energy consumption generated in machine learning is increased by approximately 30000 times. Therefore, how to reduce the energy consumption of machine learning becomes one of important research topics in future artificial intelligence development. As two training architectures that are widely used currently, centralized learning and federated learning generate different energy consumption due to different communication content and computing mechanisms. A model training method for reducing total energy consumption of a system while ensuring model performance is urgently required, to reduce environment costs brought by machine learning and achieve objectives of green artificial intelligence (green artificial intelligence, Green AI) and sustainable development.

### SUMMARY

This application provides a machine learning model training method and apparatus, to reduce energy consumption of training a machine learning model.

According to a first aspect, a machine learning model training method is provided. The method may be performed by a distributed node or a chip or a chip system on a distributed node side. The method includes: The distributed node sends a first parameter set to a central node. The first parameter set is used to determine a target training method for a machine learning model of the distributed node, and the target training method includes a first training method or a second training method. The distributed node receives a first message from the central node. The first message includes information about the target training method.

Based on the foregoing solution, the distributed node sends the first parameter set to the central node; the central node determines, based on the first parameter set, a first energy consumption index of training the machine learning model in the first training method and a second energy consumption index of training the machine learning model in the second training method, and determines the target training method for the distributed node based on the first energy consumption index and the second energy consumption index; the central node sends the information about the target training method for the distributed node to the distributed node based on the first message; and the distributed node may train the machine learning model based on the target training method indicated by the information about the target training method. The target training method is a training method in which low energy consumption is generated in a model training process, which can reduce energy consumption of training the machine learning model.

With reference to the first aspect, in some implementations of the first aspect, the first parameter set includes: energy consumption generated when the distributed node updates a local machine learning model for one time.

With reference to the first aspect, in some implementations of the first aspect, the first parameter set further includes at least one of the following parameters: a quantity of samples in a local dataset of the distributed node, a quantity of times that the distributed node performs model updating in each communication cycle, a transmit power of the distributed node, a transmission rate from the central node to the distributed node, or information about a channel from the central node to the distributed node.

With reference to the first aspect, in some implementations of the first aspect, the first training method includes a centralized learning training method, and the second training method includes a federated learning training method.

With reference to the first aspect, in some implementations of the first aspect, the method further includes: The distributed node sends a second message to the central node. The second message is used to feed back that the distributed node supports the first training method and the second training method.

According to a second aspect, a machine learning model training method is provided. The method may be performed by a central node or a chip or a chip system on a central node side. The method includes: The central node receives a first parameter set from a distributed node. The first parameter set is used to determine a target training method for a machine learning model of the distributed node, and the target training method includes a first training method or a second training method. The central node sends a first message to the distributed node. The first message includes information about the target training method.

Based on the foregoing solution, the central node may determine, based on the first parameter set sent by the distributed node, a first energy consumption index of training the machine learning model in the first training method and a second energy consumption index of training the machine learning model in the second training method, and determines the target training method for the distributed node based on the first energy consumption index and the second energy consumption index; and the central node sends the information about the target training method for the distributed node to the distributed node based on the first message, so that the distributed node may train the machine learning model in the target training method indicated by the central node. The target training method determined by the central node is a training method in which low energy consumption is generated in a model training process, which can reduce energy consumption of training the machine learning model.

With reference to the second aspect, in some implementations of the second aspect, the first parameter set includes: energy consumption generated when the distributed node updates a local machine learning model for one time.

With reference to the second aspect, in some implementations of the second aspect, the first parameter set further includes at least one of the following parameters: a quantity of samples in a local dataset of the distributed node, a quantity of times that the distributed node performs model updating in each communication cycle in the second training method, a transmit power of the distributed node, a transmission rate from the central node to the distributed node, or information about a channel from the central node to the distributed node.

With reference to the second aspect, in some implementations of the second aspect, before the central node sends the first message to the distributed node, the method further includes: The central node determines a first energy consumption index and a second energy consumption index based on the first parameter set. The first energy consumption index indicates an energy consumption level of the first training method for the machine learning model, and the second energy consumption index indicates an energy consumption level of the second training method for the machine learning model. The central node determines the target training method for the machine learning model of the distributed node based on the first energy consumption index and the second energy consumption index.

With reference to the second aspect, in some implementations of the second aspect, before the central node sends the first message to the distributed node, the method further includes: The central node determines a first energy consumption index and a second energy consumption index based on the first parameter set and a second parameter set. The second parameter set is determined by the central node, the first energy consumption index indicates an energy consumption level of the first training method for the machine learning model, and the second energy consumption index indicates an energy consumption level of the second training method for the machine learning model. The central node determines the target training method for the machine learning model of the distributed node based on the first energy consumption index and the second energy consumption index.

With reference to the second aspect, in some implementations of the second aspect, that the central node determines the target training method for the machine learning model of the distributed node based on the first energy consumption index and the second energy consumption index includes: If the first energy consumption index is greater than or equal to the second energy consumption index, the central node determines that the target training method is the second training method; or if the first energy consumption index is less than the second energy consumption index, the central node determines that the target training method is the first training method. Optionally, when the first energy consumption index is equal to the second energy consumption index, the target training method may alternatively be the first training method.

With reference to the second aspect, in some implementations of the second aspect, the second parameter set includes at least one of the following parameters: a size of the machine learning model, energy consumption generated when the central node updates the machine learning model for one time in the first training method, energy consumption generated when the central node aggregates machine learning models for one time in the second training method, an electric energy use efficiency coefficient of the central node, a transmit power of the central node, a total quantity of communication cycles of the second training method, a total quantity of times of performing model updating in the first training method, a transmission rate from the distributed node to the central node, or information about a channel from the distributed node to the central node.

With reference to the second aspect, in some implementations of the second aspect, that the central node determines a first energy consumption index and a second energy consumption index based on the first parameter set and a second parameter set includes: The central node determines the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, a transmit power of the central node, a size of the machine learning model, a transmission rate from the central node to the distributed node, and a total quantity of communication cycles of the second training method; and/or the central node determines the second energy consumption index based on a quantity of times that the distributed node performs model updating in each communication cycle in the second training method, energy consumption generated when the distributed node updates a local machine learning model for one time, a transmit power of the distributed node, a size of the machine learning model, a quantity of samples in a local dataset of the distributed node, a transmission rate from the distributed node to the central node, and a total quantity of communication cycles of the second training method.

With reference to the second aspect, in some implementations of the second aspect, that the central node determines a first energy consumption index and a second energy consumption index based on the first parameter set and a second parameter set includes: The central node determines the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, and a total quantity of communication cycles of the second training method; and/or the central node determines the second energy consumption index based on a quantity of times that the distributed node performs model updating in each communication cycle in the second training method, energy consumption generated when the distributed node updates a local machine learning model for one time, and a total quantity of communication cycles of the second training method.

With reference to the second aspect, in some implementations of the second aspect, that the central node determines a first energy consumption index and a second energy consumption index based on the first parameter set and a second parameter set includes: The central node determines the first energy consumption index based on an electric energy use efficiency coefficient of the central node, a transmit power of the central node, a size of the machine learning model, and a transmission rate from the central node to the distributed node; and/or the central node determines the second energy consumption index based on a transmit power of the distributed node, a size of the machine learning model, a quantity of samples in a local dataset of the distributed node, a transmission rate from the distributed node to the central node, and a total quantity of communication cycles of the second training method.

With reference to the second aspect, in some implementations of the second aspect, the first training method includes a centralized learning training method, and the second training method includes a federated learning training method.

With reference to the second aspect, in some implementations of the second aspect, the method further includes: The central node receives a second message from the distributed node. The second message is used to feed back that the distributed node supports the first training method and the second training method.

According to a third aspect, a communication apparatus is provided. The apparatus may be used in the distributed node in the first aspect. The apparatus includes: a sending unit, configured to send a first parameter set to a central node, where the first parameter set is used to determine a target training method for a machine learning model of a distributed node, and the target training method includes a first training method or a second training method; and a receiving unit, configured to receive a first message from the central node, where the first message includes information about the target training method.

With reference to the third aspect, in some implementations of the third aspect, the first parameter set includes: energy consumption generated when the distributed node updates a local machine learning model for one time.

With reference to the third aspect, in some implementations of the third aspect, the first parameter set further includes at least one of the following parameters: a quantity of samples in a local dataset of the distributed node, a quantity of times that the distributed node performs model updating in each communication cycle, a transmit power of the distributed node, a transmission rate from the central node to the distributed node, or information about a channel from the central node to the distributed node.

With reference to the third aspect, in some implementations of the third aspect, the first training method includes a centralized learning training method, and the second training method includes a federated learning training method.

With reference to the third aspect, in some implementations of the third aspect, the sending unit is further configured to send a second message to the central node. The second message is used to feed back that the distributed node supports the first training method and the second training method.

According to a fourth aspect, a communication apparatus is provided. The apparatus may be used in the central node in the second aspect. The apparatus includes: a receiving unit, configured to receive a first parameter set from a distributed node, where the first parameter set is used to determine a target training method for a machine learning model of the distributed node, and the target training method includes a first training method or a second training method; and a sending unit, configured to send a first message to the distributed node, where the first message includes information about the target training method.

With reference to the fourth aspect, in some implementations of the fourth aspect, the first parameter set includes: energy consumption generated when the distributed node updates a local machine learning model for one time.

With reference to the fourth aspect, in some implementations of the fourth aspect, the first parameter set further includes at least one of the following parameters: a quantity of samples in a local dataset of the distributed node, a quantity of times that the distributed node performs model updating in each communication cycle in the second training method, a transmit power of the distributed node, a transmission rate from the central node to the distributed node, or information about a channel from the central node to the distributed node.

With reference to the fourth aspect, in some implementations of the fourth aspect, the apparatus further includes a determining unit. The determining unit is configured to: determine a first energy consumption index and a second energy consumption index based on the first parameter set, where the first energy consumption index indicates an energy consumption level of the first training method for the machine learning model, and the second energy consumption index indicates an energy consumption level of the second training method for the machine learning model; and determine the target training method for the machine learning model of the distributed node based on the first energy consumption index and the second energy consumption index.

With reference to the fourth aspect, in some implementations of the fourth aspect, the apparatus further includes a determining unit. The determining unit is configured to: determine a first energy consumption index and a second energy consumption index based on the first parameter set and a second parameter set, where the second parameter set is determined by the central node, the first energy consumption index indicates an energy consumption level of the first training method for the machine learning model, and the second energy consumption index indicates an energy consumption level of the second training method for the machine learning model; and determine the target training method for the machine learning model of the distributed node based on the first energy consumption index and the second energy consumption index.

With reference to the fourth aspect, in some implementations of the fourth aspect, the determining unit is specifically configured to: if the first energy consumption index is greater than or equal to the second energy consumption index, determine that the target training method is the second training method; or if the first energy consumption index is less than the second energy consumption index, determine that the target training method is the first training method.

With reference to the fourth aspect, in some implementations of the fourth aspect, the second parameter set includes at least one of the following parameters: a size of the machine learning model, energy consumption generated when the central node updates the machine learning model for one time in the first training method, energy consumption generated when the central node aggregates machine learning models for one time in the second training method, an electric energy use efficiency coefficient of the central node, a transmit power of the central node, a total quantity of communication cycles of the second training method, a total quantity of times of performing model updating in the first training method, a transmission rate from the distributed node to the central node, or information about a channel from the distributed node to the central node.

With reference to the fourth aspect, in some implementations of the fourth aspect, the determining unit is specifically configured to: determine the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, a transmit power of the central node, a size of the machine learning model, a transmission rate from the central node to the distributed node, and a total quantity of communication cycles of the second training method; and/or determine the second energy consumption index based on a quantity of times that the distributed node performs model updating in each communication cycle in the second training method, energy consumption generated when the distributed node updates a local machine learning model for one time, a transmit power of the distributed node, a size of the machine learning model, a quantity of samples in a local dataset of the distributed node, a transmission rate from the distributed node to the central node, and a total quantity of communication cycles of the second training method.

With reference to the fourth aspect, in some implementations of the fourth aspect, the determining unit is specifically configured to: determine the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, and a total quantity of communication cycles of the second training method; and/or determine the second energy consumption index based on a quantity of times that the distributed node performs model updating in each communication cycle in the second training method, energy consumption generated when the distributed node updates a local machine learning model for one time, and a total quantity of communication cycles of the second training method.

With reference to the fourth aspect, in some implementations of the fourth aspect, the determining unit is specifically configured to: determine the first energy consumption index based on an electric energy use efficiency coefficient of the central node, a transmit power of the central node, a size of the machine learning model, and a transmission rate from the central node to the distributed node; and/or determine the second energy consumption index based on a transmit power of the distributed node, a size of the machine learning model, a quantity of samples in a local dataset of the distributed node, a transmission rate from the distributed node to the central node, and a total quantity of communication cycles of the second training method.

With reference to the fourth aspect, in some implementations of the fourth aspect, the first training method includes a centralized learning training method, and the second training method includes a federated learning training method.

With reference to the fourth aspect, in some implementations of the fourth aspect, the receiving unit is further configured to receive a second message from the distributed node. The second message is used to feed back that the distributed node supports the first training method and the second training method.

According to a fifth aspect, a communication device is provided, including a processor and a memory. The memory is configured to store a computer program, and the processor is configured to execute the computer program stored in the memory, so that the communication device performs the method according to any one of the first aspect or the possible implementations of the first aspect.

According to a sixth aspect, a communication device is provided, including a processor and a memory. The memory is configured to store a computer program, and the processor is configured to execute the computer program stored in the memory, so that the communication device performs the method according to any one of the second aspect or the possible implementations of the second aspect.

According to a seventh aspect, a communication apparatus is provided, including an input/output interface and a logic circuit. The input/output interface is configured to obtain input information and/or output information. The logic circuit is configured to perform the method according to any one of the foregoing aspects or the possible implementations of the foregoing aspects, to perform processing and/or generate output information based on the input information.

According to an eighth aspect, a communication system is provided, including: a distributed node of the method according to the first aspect or the second aspect, another communication device communicating with the distributed node, a central node, and another communication device communicating with the central node.

According to a ninth aspect, a computer-readable storage medium is provided. The computer-readable storage medium stores a computer program, and when the computer program runs on a computer, the computer is enabled to perform the method according to any one of the first aspect and the possible implementations of the first aspect.

According to a tenth aspect, a computer-readable storage medium is provided. The computer-readable storage medium stores a computer program, and when the computer program runs on a computer, the computer is enabled to perform the method according to any one of the second aspect and the possible implementations of the second aspect.

According to an eleventh aspect, a computer program product including instructions are provided. When the instructions are executed by a computer, a communication apparatus is enabled to implement the method according to any one of the first aspect and the possible implementations of the first aspect.

According to a twelfth aspect, a computer program product including instructions is provided. When the instructions are executed by a computer, a communication apparatus is enabled to implement the method according to any one of the second aspect and the possible implementations of the second aspect.

In the technical solutions provided in embodiments of this application, the distributed node sends the first parameter set to the central node; the central node determines, based on the first parameter set sent by the distributed node, a first energy consumption index of training the machine learning model in the first training method and a second energy consumption index of training the machine learning model in the second training method, and determines the target training method for the distributed node based on the first energy consumption index and the second energy consumption index; the central node sends the information about the target training method for the distributed node to the distributed node based on the first message; and the distributed node may train the machine learning model based on the target training method indicated by the information about the target training method. The target training method is a training method in which low energy consumption is generated in a model training process, which can reduce energy consumption of training the machine learning model.

### BRIEF DESCRIPTION OF DRAWINGS

FIG. 1 is a schematic diagram of a system architecture to which an embodiment of this application is applicable;

FIG. 2 is a schematic diagram of an architecture of centralized learning;

FIG. 3 is a schematic diagram of an architecture of federated learning;

FIG. 4 is a schematic diagram of an architecture of split learning;

FIG. 5 is a schematic diagram of an architecture of federated distillation;

FIG. 6 is a schematic interaction flowchart of a machine learning model training method according to an embodiment of this application;

FIG. 7 is a schematic interaction flowchart of another machine learning model training method according to an embodiment of this application;

FIG. 8 is a schematic block diagram of a communication apparatus according to an embodiment of this application;

FIG. 9 is a schematic block diagram of another communication apparatus according to an embodiment of this application; and

FIG. 10 is a schematic block diagram of a communication device according to an embodiment of this application.

### DESCRIPTION OF EMBODIMENTS

The following describes technical solutions of this application with reference to accompanying drawings.

Embodiments of this application may be applied to various communication systems such as a wireless local area network (wireless local area network, WLAN) system, a narrowband internet of things (narrowband internet of things, NB-IoT) system, a global system for mobile communications (global system for mobile communications, GSM), an enhanced data rates for GSM evolution (enhanced data rates for GSM evolution, EDGE) system, a wideband code division multiple access (wideband code division multiple access, WCDMA) system, a code division multiple access 2000 (code division multiple access, CDMA2000) system, a time division-synchronous code division multiple access (time division-synchronous code division multiple access, TD-SCDMA) system, a long term evolution (long term evolution, LTE) system, satellite communication, a 5th generation (5th generation, 5G) system, a new communication system that emerges in the future, and three application scenarios of the 5G communication system: enhanced mobile broadband (enhanced mobile broadband, eMBB), ultra-reliable and low latency communications (ultra-reliable and low latency communications, URLLC), and massive machine type communication (massive machine type communication, mMTC).

The communication system to which this application is applicable includes one or more transmitting ends and one or more receiving ends. Signal transmission between the transmitting end and the receiving end may be performed by using a radio wave, or may be performed by using a transmission medium such as visible light, a laser, infrared light, or an optical fiber. For example, one of the transmitting end and the receiving end may be a terminal device, and the other may be a network device.

The terminal device in embodiments of this application may include various handheld devices, vehicle-mounted devices, wearable devices, or computing devices that have a wireless communication function, or other processing devices connected to a wireless modem. The terminal may be a mobile station (mobile station, MS), a subscriber unit (subscriber unit), user equipment (user equipment, UE), a cellular phone (cellular phone), a smartphone (smartphone), a wireless data card, a personal digital assistant (personal digital assistant, PDA) computer, a tablet computer, a wireless modem (modem), a handheld device (handset), a laptop computer (laptop computer), a machine type communication (machine type communication, MTC) terminal, a wireless terminal in self-driving (self-driving), or the like. The user equipment includes vehicle user equipment.

For example, the network device may be an evolved NodeB (evolved NodeB, eNB), a radio network controller (radio network controller, RNC), a NodeB (NodeB, NB), a base station controller (base station controller, BSC), a base transceiver station (base transceiver station, BTS), a home evolved NodeB (home evolved NodeB, or home NodeB, HNB), a baseband unit (baseband unit, BBU), a device that bears a base station function in device to device (device to device, D2D), an access point (access point, AP) in a wireless fidelity (wireless fidelity, Wi-Fi) system, a radio relay node, a wireless backhaul node, a transmission point (transmission point, TP), a transmission and reception point (transmission and reception point, TRP), or the like; or may be a gNB or a transmission point (for example, a TRP or a TP) in new radio (new radio, NR), or one antenna panel or a group of antenna panels (including a plurality of antenna panels) of a base station in NR; or may be a network node that forms a gNB or a transmission point, for example, a baseband unit (baseband unit, BBU) or a distributed unit (distributed unit, DU). Alternatively, the network device may be a vehicle-mounted device, a wearable device, a network device in a 5G network, a network device in a future evolved PLMN network, or a network device deployed on a satellite. This is not limited.

The network device has abundant product forms. For example, in a product implementation process, the BBU and a radio frequency unit (radio frequency unit, RFU) may be integrated into a same device, and the device is connected to an antenna array by using a cable (for example but not limited to a feeder). The BBU and the RFU may alternatively be disposed separately, are connected by using an optical fiber, and communicate with each other by using, for example but not limited to a common public radio interface (common public radio interface, CPRI) protocol. In this case, the RFU is usually referred to as a remote radio unit (remote radio unit, RRU), and is connected to the antenna array by using a cable. In addition, the RRU may alternatively be integrated with the antenna array. For example, this structure is used for an active antenna unit (active antenna unit, AAU) product in a current market.

In addition, the BBU may be further divided into a plurality of parts. For example, the BBU may be further divided into a central unit (central unit, CU) and a distributed unit (distributed unit, DU) based on real-time performance of a processed service. The CU is responsible for processing a non-real-time protocol and service, and the DU is responsible for processing a physical layer protocol and a real-time service. Further, some physical layer functions may be separated from the BBU or the DU and integrated into an AAU.

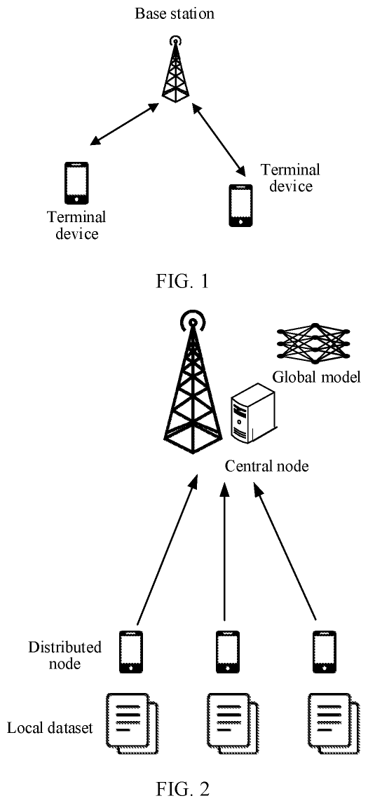

FIG. 1 is a schematic diagram of a system architecture to which an embodiment of this application is applicable. A network device in this embodiment of this application may be a base station. The base station may be a central node, and the terminal device may be a distributed node; or the base station may be a distributed node, and the terminal device may be a central node.

With advent of a big data era, each device generates massive raw data in various forms every day. The data is generated in a form of an “island” and exists in every corner of the world. In conventional centralized learning, all edge devices (distributed nodes) need to transmit local data to a server at a central end (central node) uniformly, and then performs model training and learning based on collected data. However, this architecture is gradually limited by the following factors as the era develops:
(1) Edge devices are widely distributed in various regions and corners of the world. These devices continuously generate and accumulate massive amounts of raw data at a fast speed. If the central end needs to collect raw data from all edge devices, huge communication loss and computing power requirements are inevitably caused.
(2) As actual scenarios in real life become more complex, more learning tasks require that the edge device can make a timely and effective decision and feedback. In conventional centralized learning, a large amount of data is uploaded, and a large latency is inevitably caused. Consequently, centralized learning cannot meet a real-time requirement of an actual task scenario.
(3) In consideration of problems such as industry competition, user privacy security, and complex administrative procedures, centralized integration of data faces increasing resistance and constraints. Therefore, for system deployment, data increasingly tends to be locally stored, and the edge device completes local computing of a model.

Therefore, how to design a machine learning framework while meeting data privacy, security, and regulatory requirements to enable an artificial intelligence (artificial intelligence, AI) system to jointly use data of devices more efficiently and accurately becomes an important issue in current development of artificial intelligence.

To fully use data samples of a plurality of terminal devices for training, there are currently two typical training architectures of a machine learning model: (1) Centralized learning (centralized learning, CL): A plurality of terminal devices (edge devices/distributed nodes) directly upload collected raw data samples to a central node, and the central node performs centralized training. (2) Federated learning (federated learning, FL): A plurality of terminal devices perform training by using an existing model and a local data sample, and then upload a parameter or parameter gradient of an updated local model to a central node. Then, the central node aggregates models or gradients, and delivers an updated global model or gradient to each terminal device. The foregoing steps are repeatedly performed until the model converges. Due to massive data information of the terminal device, a high-performance machine learning model can be obtained through both centralized learning and federated learning.

A breakthrough is made in machine learning in a plurality of fields such as computer vision, natural language processing, and wireless communication. However, as complexity of a machine learning algorithm continuously increases, training of many models such as a GPT-3 model consumes a large amount of energy, resulting in huge environmental costs such as emission (carbon footprint) of greenhouse gases such as carbon dioxide and methane. From 2012 to 2018, energy consumption generated in machine learning is increased by approximately 30000 times. Therefore, how to reduce the energy consumption of machine learning becomes one of important research topics in future artificial intelligence development. As two training architectures that are widely used currently, centralized learning and federated learning generate different energy consumption due to different communication content and computing mechanisms. A solution to switching between different training methods based on energy efficiency is urgently required, to reduce total energy consumption of a system while ensuring performance of the machine learning model, so as to reduce environment costs brought by machine learning and achieve objectives of green artificial intelligence (green artificial intelligence, Green AI) and sustainable development.

To facilitate understanding of the technical solutions in embodiments of this application, centralized learning, federated learning, split learning, and federated distillation in the conventional technology are briefly described.

### I. Centralized Learning

To use distributed node data distributed on a network edge side for model training, a centralized learning architecture is used for training in an existing technology. FIG. 2 is a schematic diagram of an architecture of centralized learning. In centralized learning, each distributed node needs to directly upload a collected data sample to a central node located on a base station, and the central node performs centralized training. Due to high-density integration of the base station (data center), high heat is generated in a running process of the base station. To resolve a problem such as heat dissipation of a device, extra energy needs to be consumed during model training, to cool the device. Therefore, energy consumption of centralized learning mainly includes the following three parts:
(1) Data transmission energy consumption: This part of energy consumption mainly depends on a size of a local dataset of the distributed node, a transmission power of the distributed node, and a transmission power of an uplink channel of the distributed node.
(2) Computing energy consumption of the central node: This part of energy consumption mainly depends on a computing power of the central node, complexity of a training model, and a power at which computing is performed that are of the central node.
(3) Cooling energy consumption of the central node: This part of energy consumption is usually positively correlated with the computing energy consumption of the central node and is related to a hardware configuration of the central node.

In centralized learning, the distributed node directly uploads data, and the central node performs centralized training. An advantage of centralized learning is that training data needs to be uploaded for only one time, and when a training data amount is small, transmission overheads are also low. Centralized learning mainly has the following three disadvantages:
(1) Data privacy disclosure: Data of the distributed node includes user privacy information, and is easily intercepted by a third party in a data uploading process, leading to privacy disclosure.
(2) Single point of failure: In centralized learning, the central node performs central training. Once the central node is attacked or faulty and cannot work, an entire training task is suspended.
(3) Too high system energy consumption in some scenarios: When a total data amount of the distributed node is very large and a communication bandwidth is limited, the distributed node directly uploads data, and very high transmission energy consumption is generated. When the computing power of the central node is limited and model complexity is high, very high computing energy consumption and cooling energy consumption are generated when only the central node performs training.

### II. Federated Learning

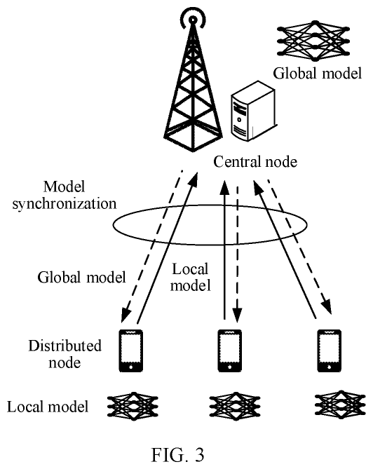

A concept of federated learning effectively resolves difficulty faced by current artificial intelligence development. When user data privacy and security are fully ensured, each distributed node and a central node cooperate to efficiently complete a model learning task. FIG. 3 is a schematic diagram of an architecture of federated learning. An FL architecture is a currently most widely used training architecture in the FL field. A FedAvg algorithm is a basic algorithm of FL. An algorithm procedure of the FedAvg algorithm is as follows:
(1) The central node initiates a to-be-trained model w_{g}⁰, and broadcasts the to-be-trained model to all distributed nodes.
(2) In a t^{th} (t∈[1,T]) round, a distributed node k∈[1,K] performs E epochs (epoch) of training on a received global model w_{g}^{t-1} based on a local dataset Dₖ, to obtain a local training result wₖ^{t}, and reports the local training result to the central node.
(3) The central node collects local training results from all or some distributed nodes. It is assumed that a set of distributed nodes that upload a local model in a t^{th} round is S′. The central node performs weighted averaging by using a quantity of samples of a corresponding distributed node as a weight, to obtain a new global model. A specific updating rule is

$${w}_{g}^{t} = \sum k ∈ {S}^{t} \frac{{D}_{k} {w}_{k}^{t}}{\sum k ∈ {S}^{t} {D}_{k}} .$$

Then, the central node broadcasts a global model w_{g}^{t} of a latest version to all distributed nodes, to perform a new round of training.
(4) Steps (2) and (3) are repeated, until the model converges finally or a quantity of training rounds reaches an upper limit.

In addition to the local model wₖ^{t}, the central node may further report a local gradient gₖ^{t} of training. In this case, the central node averages local gradients, and updates the global model based on a direction of an average gradient.

It can be learned that, in the FL architecture, a dataset exists on the distributed node. To be specific, the distributed node collects local datasets, performs local training, and reports a local result obtained through training to the central node, for example, reports a model or a gradient obtained through training to the central node. The central node does not have a dataset, is only responsible for fusing training results of the distributed nodes to obtain a global model, and delivers the global model to the distributed node.

Energy consumption of federated learning mainly includes five parts:
(1) Computing energy consumption of the distributed node: This part of energy consumption mainly depends on a computing power, a power at which computing is performed, and a quantity of times of updating a local model that are of the distributed node.
(2) Transmission energy consumption of the distributed node: This part of energy consumption mainly depends on a size of a machine learning model, and an uplink transmission rate and an uplink transmission power of the distributed node.
(3) Computing energy consumption of the central node: This part of energy consumption depends on the size of the machine learning model, a quantity of distributed nodes, and a computing power and a power at which computing is performed that are of the central node.
(4) Transmission energy consumption of the central node: This part of energy consumption depends on the size of the machine learning model, and a downlink transmission rate and a downlink transmission power of the central node.
(5) Cooling energy consumption of the central node: This part of energy consumption is usually positively correlated with the computing energy consumption of the central node and is related to a hardware configuration of the central node.

Training data does not need to be uploaded in a training process of federated learning, to protect data privacy. In addition, when the machine learning model is small and a training data amount is large, communication overheads of federated learning are low. However, federated learning also has disadvantages. For example, in some scenarios, a system training time is too long and energy consumption is too high. When a data distribution of the distributed node is a non-independent and identical distribution (non-independent and identical distribution, Non-IID) and is unbalanced, and the machine learning model is large, the global model obtained by the central node through aggregation is biased (biased). In this case, a quantity of communication cycles required for federated learning to achieve model convergence is very large, resulting in a too long training time and too high system energy consumption.

### III. Split Learning

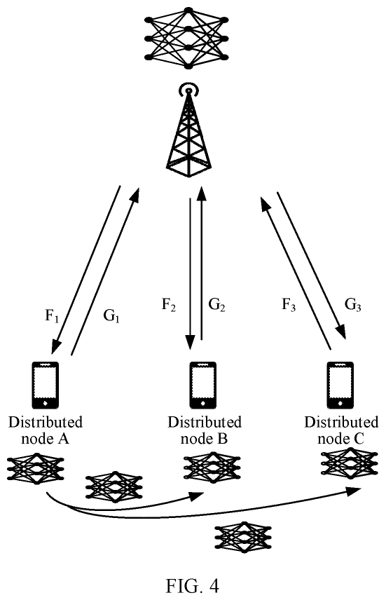

Split learning is also a distributed learning method. A complete machine learning model, for example, a neural network is divided into a plurality of parts and deployed on a plurality of different devices. FIG. 4 is a schematic diagram of an architecture of split learning. For example, distributed nodes include a distributed node A, a distributed node B, and a distributed node C. A training process of the machine learning model is as follows:

(1) The distributed node A inputs local data into a local machine learning submodel for inference, to obtain an inference result of inference at the cut layer.
(2) The distributed node A sends the inference result of the cut layer to the central node through a communication link.
(3) The central node inputs the received inference result of the cut layer into a machine learning submodel on the central node. The machine learning submodel on the central node and the submodel on the distributed node form a complete machine learning model. The central node continues to perform inference, to obtain an inference result.
(4) The central node computes a loss function based on an inference result output of the machine learning submodel, performs gradient computing and reverse transfer, and updates a submodel parameter, to finally obtain a gradient reverse transfer result of the cut layer.
(5) The central node sends the gradient reverse transfer result of the cut layer to the distributed node A through the communication link.
(6) After receiving the gradient reverse transfer result of the cut layer, the distributed node A continues to compute a parameter gradient of a local submodel, and continues to perform a gradient reverse transfer and parameter updating of the local submodel.
(7) (1) to (6) are repeated, until a training convergence condition is met, for example, a maximum quantity of training times is reached or a performance requirement is met.

Optionally, the distributed node A may send a parameter of the local submodel to another distributed node, and the another distributed node, for example, the distributed node B or the distributed node C, continues to train the machine learning model based on local data of the another distributed node. It can be learned that, in split learning, the distributed node and the central node exchange the inference result or the gradient reverse transfer result of the cut layer, instead of raw data. Therefore, data privacy can be protected. In addition, the inference result or the gradient reverse transfer result of the cut layer is only related to a quantity of neurons of the cut layer. Therefore, communication overheads are low.

### IV. Federal Distillation

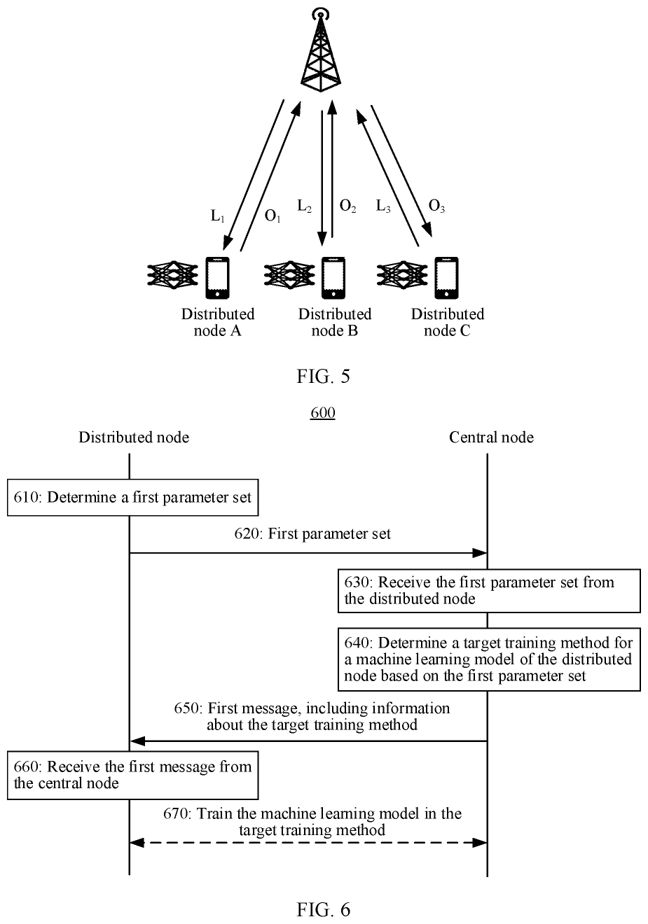

Federated distillation is also a feasible distributed learning method. Similar to federated learning, a plurality of distributed nodes exchange information with a central node, to jointly complete training of a machine learning model. FIG. 5 is a schematic diagram of an architecture of federated distillation. Different from federated learning, the information exchanged between the distributed node and the central node in federated distillation is log its (log its), rather than a model parameter or a gradient parameter in federated learning. A training process of the machine learning model is similar to that of federated learning, and an advantage of federated distillation is that communication overheads are low in a scenario in which data privacy can be protected and a model is small. Details are not described herein again.

An embodiment of this application provides a machine learning model training method, to reduce energy consumption of training a machine learning model.

FIG. 6 is a schematic interaction flowchart of a machine learning model training method 600 according to an embodiment of this application. In this embodiment of this application, a central node may be a base station, and a distributed node may be a terminal device; or a central node may be a terminal device, and a distributed node may be a base station; or a central node and a distributed node each are a base station; or a central node and a distributed node each are a terminal device. This application sets no specific limitation thereto.
610: The distributed node determines a first parameter set, where the first parameter set is used to determine a target training method for a machine learning model of the distributed node, and the target training method may be a first training method or a second training method. Optionally, the first training method includes a centralized learning training method, the second training method includes a federated learning training method, and the second training method may further include a split learning training method, a federated distillation training method, or another training method. It should be understood that there may be one or more distributed nodes that participate in training of the machine learning model, and there may also be one or more distributed nodes that send the first parameter set to the central node.

For example, the first parameter set includes energy consumption generated when the distributed node updates a local machine learning model for one time, for example, energy consumption generated when the distributed node updates the local machine learning model for one time in the federated learning training method. The energy consumption may be obtained by the distributed node by computing an average through a plurality of experiments. For example, if a distributed node k performs local updating/pre-training for mₖ times and counts total energy Eₖ consumed during local updating/pre-training, energy consumption eₖ^{t} generated when the local machine learning model is updated for one time may be approximately

$${e}_{k}^{l} = \frac{{E}_{k}}{{m}_{k}} .$$

Herein, mₖ is a positive integer, k is a positive integer less than or equal to K, and K is a quantity of distributed nodes that train the machine learning model.

For example, the first parameter set may further include at least one of the following parameters:
(1) Quantity of samples in a local dataset of the distributed node: For example, if the distributed node k counts a quantity nₖ of pieces of data in the local dataset, and computes a quantity bₖ of quantized bits of each piece of data, the quantity of samples in the local dataset of the distributed node k is Dₖ=bₖnₖ.
(2) Quantity of times that the distributed node performs model updating in each communication cycle: For example, for a quantity τₖ of times that the distributed node k performs model updating in each communication cycle in the federated learning training method, τₖ may be determined by the distributed node based on a computing power of the distributed node. Optionally, τₖ may alternatively be determined by the central node and indicated to the distributed node.
(3) Transmit power of the distributed node: For example, a transmit power pₖ of the distributed node k may be determined based on a power control algorithm used in a communication system. Optionally, the transmit power of the distributed node may alternatively be determined by the central node and indicated to the distributed node.
(4) Transmission rate from the central node to the distributed node or information about a channel from the central node to the distributed node: The information about the channel from the central node to the distributed node may be used to determine the transmission rate from the central node to the distributed node. Specifically, the distributed node may estimate the transmission rate from the central node to the distributed node based on the information about the channel, signal to interference plus noise ratio (signal to interference plus noise ratio, SINR) information, a decoding situation, and an existing adaptive modulation and coding algorithm; or may compute and determine the transmission rate r̅ from the central node to the distributed node based on a transmit power of the central node, a channel situation, and a Shannon's equation. The computing formula is shown in Formula (1):

$$\overline{r} = {min}_{k} \{ B log ( 1 + \frac{{p}^{B} {‖ \overline{{h}_{k}^{D}} ‖}^{2}}{{N}_{0}} ) \} \qquad ( 1 )$$

Herein, p^{B} is the transmit power of the central node, and may be determined based on the power control algorithm used in the communication system; h̅ₖ̅^̅{̅D̅}̅ is a gain of a channel from the central node to the distributed node k, and may be obtained in channel estimation and channel information feedback methods used in the communication system; B is a bandwidth used when the central node performs downlink transmission; N₀ is a noise power; and minₖ represents a minimum value.
620: The distributed node sends the first parameter set to the central node.
630: The central node receives the first parameter set from the distributed node.
640: The central node determines the target training method for the machine learning model of the distributed node based on the first parameter set.

In an implementation, the central node may determine a first energy consumption index and a second energy consumption index based on a parameter in the first parameter set, the first energy consumption index indicates an energy consumption level of the first training method for the machine learning model, and the second energy consumption index indicates an energy consumption level of the second training method for the machine learning model. The central node determines the target training method for the machine learning model of the distributed node based on the first energy consumption index and the second energy consumption index. Optionally, if the first energy consumption index is greater than or equal to the second energy consumption index, the central node may determine that the target training method is the second training method. It may be understood that the second training method is determined as the target training method for the machine learning model of the distributed node. If the first energy consumption index is less than the second energy consumption index, the central node may determine that the target training method is the first training method. It may be understood that the first training method is determined as the target training method for the machine learning model of the distributed node. Optionally, if the first energy consumption index is greater than the second energy consumption index, the central node may determine that the target training method is the second training method; or if the first energy consumption index is less than or equal to the second energy consumption index, the central node may determine that the target training method is the first training method. It should be understood that when the first energy consumption index is equal to the second energy consumption index, the target training method may be the first training method, or may be the second training method.

In another implementation, the central node may determine a first energy consumption index and a second energy consumption index based on a parameter in the first parameter set and a parameter in a second parameter set, the first energy consumption index indicates an energy consumption level of the first training method for the machine learning model, and the second energy consumption index indicates an energy consumption level of the second training method for the machine learning model. The second parameter set is determined by the central node. The central node determines the target training method for the machine learning model of the distributed node based on the first energy consumption index and the second energy consumption index. Optionally, if the first energy consumption index is greater than or equal to the second energy consumption index, the central node may determine that the target training method is the second training method; or if the first energy consumption index is less than the second energy consumption index, the central node may determine that the target training method is the first training method. Optionally, if the first energy consumption index is greater than the second energy consumption index, the central node may determine that the target training method is the second training method; or if the first energy consumption index is less than or equal to the second energy consumption index, the central node may determine that the target training method is the first training method. It should be understood that when the first energy consumption index is equal to the second energy consumption index, the target training method may be the first training method, or may be the second training method.

Optionally, the second parameter set may include at least one of the following parameters:
(1) Size M of the machine learning model: The size of the machine learning model is determined based on a quantity N of parameters and a quantity b of quantized bits of each parameter, and the size of the model may be approximately M=bN.
(2) Energy consumption generated when the central node updates the machine learning model for one time in the first training method: The first training method may be a centralized learning training method. The energy consumption may be obtained by the distributed node by computing an average through a plurality of experiments. For example, if the central node performs model updating/pre-training for m times and counts energy E′ consumed during model training, energy consumption of performing model updating for one time during local updating/pre-training may be approximately

$${e}^{l} = \frac{{E}^{l}}{m} .$$

(3) Energy consumption generated when the central node updates the machine learning model or aggregates machine learning models for one time in the second training method: The second training method may be a federated learning training method. The energy consumption may alternatively be obtained by the distributed node by computing an average through a plurality of experiments. For example, if the central node aggregates model parameters or parameter gradients for m times and counts total energy E^{A} consumed during model parameter aggregation or parameter gradient aggregation, energy consumption of performing model updating for one time may be approximately

$${e}^{A} = \frac{{E}^{A}}{m} .$$

(4) Electric energy use efficiency coefficient of the central node: The electric energy use efficiency coefficient γ of the central node is computed as follows: If total consumed electric energy E is counted in a model updating/pre-training process, the electric energy use efficiency coefficient may be approximately

$$γ = \frac{E}{{E}^{l}} .$$

(5) Transmit power p^{B} of the central node:
(6) Total quantity of communication cycles of the second training method: The second training method may be the federated learning training method. In this case, the total quantity of communication cycles of the second training method may be represented as T_{FL}.
(7) Total quantity of times of performing model updating in the first training method: The first training method may be the centralized learning training method. In this case, the total quantity of times of performing model updating in the first training method may be represented as T_{CL}.
(8) Transmission rate from the distributed node to the central node or information about a channel from the distributed node to the central node: The information about the channel from the distributed node to the central node may be used to determine the transmission rate from the distributed node to the central node. Specifically, the distributed node may estimate the transmission rate from the distributed node to the central node based on the information about the channel, the SINR information, the decoding situation, and the existing adaptive modulation and coding algorithm; or may compute and determine the transmission rate r̅ₖ from the distributed node to the central node based on the transmit power of the distributed node, the channel situation, and the Shannon's equation. The computing formula is shown in Formula (2):

$$\overline{{r}_{k}} = {B}_{k} log ( 1 + \frac{{p}_{k} {‖ \overline{{h}_{k}^{U}} ‖}^{2}}{{N}_{0}} ) \qquad ( 2 )$$

Herein, pₖ is the transmit power of the distributed node k, and may be obtained based on the power control algorithm used in the communication system; the transmit power of the distributed node may be determined by the central node, or may be determined by the distributed node and indicated to the central node; h̅ₖ̅^̅{̅U̅}̅ is a gain of a channel from the distributed node k to the central node; Bₖ is a bandwidth used when the distributed node k performs uplink transmission, and may be obtained based on a bandwidth allocation algorithm used in the communication system; and N₀ is a noise power.

For example, the parameter in the first parameter set and the parameter in the second parameter set that are used to compute an energy consumption index may be classified into three types, respectively including a transmission parameter, an energy consumption parameter, and a learning parameter. Table 1 shows a parameter list of three types of parameters.

TABLE 1
Parameter list of three types of parameters

| Parameter type | Parameter | Symbol |
|---|---|---|
| Energy | Energy consumption generated when a central node updates a | e^{l} |
| consumption | machine learning model for one time in a first training | |
| parameter | method | |
| | Energy consumption generated when the central node | e^{A} |
| | aggregates machine learning models for one time in a second | |
| | training method | |
| | Energy consumption generated when a distributed node | eₖ^{l} |
| | updates a local machine learning model for one time | |
| | Electric energy use efficiency coefficient of a central node | γ |
| Transmission | Transmission rate from the central node to the distributed node | r̅ |
| parameter | Transmission rate from the distributed node to the central node | r̅ₖ |
| Learning | Size of the machine learning model | M |
| parameter | Total quantity of communication cycles of the second training | T_{FL} |
| | method | |
| | Total quantity of times of performing model updating in the | T_{CL} |
| | first training method | |
| | Quantity of times that the distributed node performs model | τₖ |
| | updating in each communication cycle | |
| | Quantity of samples in a local dataset of the distributed node | Dₖ |

When the energy consumption index is determined, not all of the foregoing parameters are required, but only some of the foregoing parameters may be required, and a parameter other than the foregoing parameters may be required. This is not specifically limited in this application. A parameter may be obtained based on a requirement in a used energy consumption index computing method.

Specifically, the central node may determine the first energy consumption index and the second energy consumption index based on the first parameter set and the second parameter set in a plurality of manners.

For example, the central node may determine the first energy consumption index based on the electric energy use efficiency coefficient of the central node, the energy consumption generated when the central node updates the machine learning model for one time in the first training method, the total quantity of times of performing model updating in the first training method, the energy consumption generated when the central node aggregates machine learning models for one time in the second training method, the transmit power of the central node, the size of the machine learning model, the transmission rate from the central node to the distributed node, and the total quantity of communication cycles of the second training method; and/or the central node may determine the second energy consumption index based on the quantity of times that the distributed node performs model updating in each communication cycle in the second training method, the energy consumption generated when the distributed node updates the local machine learning model for one time, the transmit power of the distributed node, the size of the machine learning model, the quantity of samples in the local dataset of the distributed node, the transmission rate from the distributed node to the central node, and the total quantity of communication cycles of the second training method.

For example, the central node may determine the first energy consumption index based on the electric energy use efficiency coefficient of the central node, the energy consumption generated when the central node updates the machine learning model for one time in the first training method, the total quantity of times of performing model updating in the first training method, the energy consumption generated when the central node aggregates machine learning models for one time in the second training method, and the total quantity of communication cycles of the second training method; and/or the central node may determine the second energy consumption index based on the quantity of times that the distributed node performs model updating in each communication cycle in the second training method, the energy consumption generated when the distributed node updates the local machine learning model for one time, and the total quantity of communication cycles of the second training method.

For example, the central node may determine the first energy consumption index based on the electric energy use efficiency coefficient of the central node, the transmit power of the central node, the size of the machine learning model, and the transmission rate from the central node to the distributed node; and/or the central node may determine the second energy consumption index based on the transmit power of the distributed node, the size of the machine learning model, the quantity of samples in a local dataset of the distributed node, the transmission rate from the distributed node to the central node, and the total quantity of communication cycles of the second training method.
650: The central node sends a first message to the distributed node, where the first message includes information about the target training method, and the information about the target training method indicates the distributed node to train the machine learning model in the target training method. The central node may indicate, by using a message or signaling, the target training method for the distributed node to the distributed node that accesses the central node. For example, the central node may send downlink control information (downlink control information, DCI) to the distributed node to indicate the target training method for the distributed node. A 1-bit training method indicator bit may be added to the DCI. When the indicator bit is “0”, the distributed node may be indicated to train the machine learning model in the first training method. When the indicator bit is “1”, the distributed node may be indicated to train the machine learning model in the second training method. For another example, a 1-bit training method indicator bit may be added to broadcast information. When the indicator bit is “0”, the distributed node that accesses the central node may be indicated to train the machine learning model in the first training method; or when the indicator bit is “1”, the distributed node that accesses the central node may be indicated to train the machine learning model in the second training method.
660: The distributed node receives the first message from the central node, where the first message includes the information about the target training method. Optionally, the information about the target training method may indicate the distributed node to train the machine learning model in the first training method, or may indicate the distributed node to train the machine learning model in the second training method. For example, the information about the target training method may indicate the distributed node to train the machine learning model in the centralized learning training method. For another example, the information about the target training method may indicate the distributed node to train the machine learning model in the federated learning training method.
670: The distributed node and the central node train the machine learning model in the target training method.

Optionally, before the central node receives the first parameter set from the distributed node, the central node may further indicate, by sending control signaling, a plurality of distributed nodes to start a process of selecting a machine learning model training method. In addition, the central node needs to feed back, to the distributed node, whether the central node needs to participate in model training. If some distributed nodes support only one training method, the distributed nodes do not need to select a training method.

For example, the distributed node may send a second message to the central node. The second message is used to feed back that the distributed node supports the first training method and the second training method. In other words, the distributed node needs to select a training method. Correspondingly, the central node receives the second message from the distributed node, and determines, based on the second message, that the distributed node supports the first training method and the second training method. It should be understood that, if a distributed node supports only the first training method or the second training method, the distributed node does not need to select a training method, and does not need to send, to the central node, the first parameter set determined by the distributed node. The second message may be a feedback message sent by the distributed node in response to the control signaling that is sent by the central node and that indicates to start the process of selecting the machine learning model training method, or may be actively sent by a distributed node that participates in training of the machine learning model. This is not specifically limited in this application.

When the plurality of distributed nodes send respectively determined first parameter sets to the central node, the central node may separately determine a target training method for a machine learning model of each distributed node. Target training methods of different distributed nodes may be different or may be the same. Specifically, the central node may determine, based on a first parameter set sent by each distributed node that needs to select a training method, the first energy consumption index existing when the distributed node uses the first training method and the second energy consumption index existing when the distributed node uses the second training method, and determine the target training method for the machine learning model of the distributed node based on the first energy consumption index and the second energy consumption index.

When the plurality of distributed nodes send respectively determined first parameter sets to the central node, the central node may determine a target training method for a unified machine learning model of the plurality of distributed nodes. In other words, target training methods for all distributed nodes are the same, and a same training method is uniformly used in the entire system. Specifically, the central node may determine, based on a plurality of different first parameter sets sent by the plurality of distributed nodes, a first energy consumption index existing when the plurality of distributed nodes use the first training method and the second energy consumption index existing when the plurality of distributed nodes use the second training method, and determine the target training method for machine learning models of all distributed nodes based on the first energy consumption index and the second energy consumption index.

For example, energy consumption includes transmission energy consumption, computing energy consumption, and cooling energy consumption. A specific energy consumption index deduction process is as follows:

Energy consumption of the centralized learning training method mainly includes three parts: data transmission energy consumption, computing energy consumption of the central node, and cooling energy consumption of the central node. A case in which the transmit power of the distributed node k is pₖ, the quantity of samples in the local dataset of the distributed node k is Dₖ, and the transmission rate from the distributed node k to the central node is rₖ is defined. Because data of each distributed node needs to be transmitted to the central node for only one time, total data transmission energy consumption of K distributed nodes may be represented in Formula (3):

$${E}_{trans} = {\sum }_{k = 1}^{K} {p}_{k} \frac{{D}_{k}}{{r}_{k}} \qquad ( 3 )$$

A case in which energy consumption generated when the central node updates the machine learning model for one time in the centralized learning training method is e^{l}, and a total quantity of times of performing model updating in the centralized learning training method is T_{CL} is defined. In this case, the computing energy consumption of the central node may be represented in Formula (4):

$${E}_{train} = {e}^{l} {T}_{CL} \qquad ( 4 )$$

The cooling energy consumption of the central node is E_{cool}=(γ−1)Tₜᵣₐᵢₙ. Herein, γ>1 is the electric energy use efficiency coefficient of the central node. Based on the foregoing analysis, total energy consumption of the centralized learning training method may be represented in Formula (5):

$${E}_{CL} = {E}_{trans} + {E}_{train} + {E}_{cool} = {\sum }_{k = 1}^{K} {p}_{k} \frac{{D}_{k}}{{r}_{k}} + γ {e}^{l} {T}_{CL} \qquad ( 5 )$$

Energy consumption of the federated learning training method mainly includes five parts: computing energy consumption of the distributed node, transmission energy consumption of the distributed node, computing energy consumption of the central node, transmission energy consumption of the central node, and cooling energy consumption of the central node. In consideration that in the t^{th} communication cycle, a case in which the transmit power of the distributed node k is pₖ, a transmission rate of the distributed node k is rₖ^{t}, the quantity of times that the distributed node k performs model updating in each communication cycle in the federated learning training method is τₖ, energy consumption generated when the distributed node k updates the local machine learning model for one time in the federated learning training method is eₖ^{t}, and the size of the machine learning model is M is defined. In this case, computing energy consumption of the distributed node in a t^{th} communication cycle may be represented in Formula (6), and transmission energy consumption of the distributed node in the t^{th} communication cycle may be represented in Formula (7):

$${E}_{k , train}^{t} = {τ}_{k} {e}_{k}^{l} \qquad ( 6 )$$

$${E}_{k , trans}^{t} = {p}_{k} \frac{M}{{r}_{k}^{t}} \qquad ( 7 )$$

On a central node side, a case in which energy consumption generated when the central node updates the machine learning model or aggregates machine learning models for one time in the federated learning training method is e^{A}, the transmit power of the central node is p^{B}, and the transmission rate from the central node to the distributed node is r^{t} is defined. In this case, computing energy consumption of the central node in the t^{th} communication cycle may be represented in Formula (8), and transmission energy consumption of the central node in the t^{th} communication cycle may be represented in Formula (9):

$${E}_{aggre}^{t} = {e}^{A} \qquad ( 8 )$$

$${E}_{trans}^{t} = {p}^{B} \frac{M}{{r}^{t}} \qquad ( 9 )$$

Correspondingly, the cooling energy consumption of the central node is E_{cool}^{t}=(γ−1)(E_{aggre}^{t}+Eₜᵣₐₙₛ^{t}). In this case, the energy consumption of the federated learning in the t^{th} communication cycle may be represented in Formula (10):

$${E}^{t} = {\sum }_{k - 1}^{K} ( {E}_{k , train}^{t} + {E}_{k , trans}^{t} ) + {E}_{aggre}^{t} + {E}_{trans}^{t} + {E}_{cool}^{t} = {\sum }_{k - 1}^{K} ( {τ}_{k} {e}_{k}^{l} + {P}_{k} \frac{M}{{r}_{k}^{t}} ) + γ ( {e}^{A} + {p}^{B} \frac{M}{{r}^{t}} ) \qquad ( 10 )$$

A case in which a total quantity of communication cycles of the federated learning training method is T_{FL} is defined. In this case, total energy consumption of the federated learning training method may be represented in Formula (11):

$${E}_{FL} = {\sum }_{t = 1}^{{T}_{FL}} {E}^{t} = {T}_{FL} ( {\sum }_{k = 1}^{K} {τ}_{k} {e}_{k}^{l} + {γe}^{A} ) + {\sum }_{t = 1}^{{T}_{FL}} ( γ {p}^{B} \frac{M}{{r}^{t}} + {\sum }_{k = 1}^{K} {p}_{k} \frac{M}{{r}_{k}^{t}} ) \qquad ( 11 )$$

Due to a dynamic feature of a radio channel, an expectation is computed for an uplink channel and a downlink channel, to obtain Formula (12):

$$IE \{ {E}_{FL} - {E}_{CL} \} \approx {\sum }_{k = 1}^{K} [ ( {τ}_{k} {e}_{k}^{l} + {p}_{k} \frac{M - \frac{{D}_{k}}{{T}_{FL}}}{{\overline{r}}_{k}} ) ] {T}_{FL} - γ [ {e}^{l} {T}_{CL} - ( {e}^{A} + {p}^{B} \frac{M}{\overline{r}} ) {T}_{FL} ] \qquad ( 12 )$$

Herein, r̅ is an average transmission rate from the central node to the distributed node, and r̅ₖ̅ is an average transmission rate from the distributed node to the central node. Therefore, an energy consumption index of the centralized learning training method may be obtained and represented in Formula (13):

$$G ( γ , {e}^{l} , {T}_{CL} , {e}^{A} , {p}^{B} , M , \overline{r} , {T}_{FL} ) = γ [ {e}^{l} {T}_{CL} - ( {e}^{A} + {p}^{B} \frac{M}{\overline{r}} ) {T}_{FL} ] \qquad ( 13 )$$

The energy consumption index of the federated learning training method may be represented in Formula (14):

$$F ( {τ}_{k} , {e}_{k}^{l} , {p}_{k} , M , {D}_{k} , {\overline{r}}_{k} , {T}_{FL} ) = {\sum }_{k = 1}^{K} [ ( {τ}_{k} {e}_{k}^{l} + {p}_{k} \frac{M - \frac{{D}_{k}}{{T}_{FL}}}{{\overline{r}}_{k}} ) ] {T}_{FL} \qquad ( 14 )$$

Formula (13) is used to compute a total energy consumption index of all the distributed nodes that exists when all the distributed nodes uniformly use the centralized learning training method. Formula (14) is used to compute a total energy consumption index of all the distributed nodes that exists when all the distributed nodes uniformly use the federated learning training method.

When different distributed nodes are allowed to use different training methods, F(τₖ, eₖ^{l}, pₖ, M, Dₖ, r̅ₖ, T_{FL}) is divided by T_{FL} and a k^{th} item is obtained, so that an energy consumption index of the distributed node k in the centralized learning training method can be obtained and represented in Formula (15):

$$g ( γ , {e}^{l} , {T}_{CL} , {e}^{A} , {p}^{B} , M , \overline{r} , {T}_{FL} ) = \frac{γ}{K} [ {e}^{l} \frac{{T}_{CL}}{{T}_{FL}} - ( {e}^{A} + {p}^{B} \frac{M}{\overline{r}} ) ] \qquad ( 15 )$$

An energy consumption index of the distributed node k in the federated learning training method may be represented in Formula (16):

$${f}_{k} ( {τ}_{k} , {e}_{k}^{l} , {p}_{k} , M , {D}_{k} , {\overline{r}}_{k} , {T}_{FL} ) = {τ}_{k} {e}_{k}^{l} + {p}_{k} \frac{M - \frac{{D}_{k}}{{T}_{FL}}}{{\overline{r}}_{k}} \qquad ( 16 )$$

For derivation performed when only the computing energy consumption or the transmission energy consumption is considered, an energy consumption index may be obtained by simply setting some parameters in E_{CL} and E_{FL} to zero.

For example, the first training method is the centralized learning training method, and the second training method is the federated learning training method. Determining of the first energy consumption index and the second energy consumption index and determining of the target training method based on the first energy consumption index and the second energy consumption index are described by using an example. It should be understood that the first training method may be any one of the four training methods (the centralized learning method, the federated learning method, the split learning method, and the federated distillation training method) or another training method, and the second training method may also be any one of the four training methods or another training method. However, the first training method and the second training method are different training methods.

### I. Three Parts of Energy Consumption, Namely, the Transmission Energy Consumption, the Computing Energy Consumption, and the Cooling Energy Consumption are Considered.

For example, the central node may determine the first energy consumption index based on the electric energy use efficiency coefficient γ of the central node, the energy consumption e^{l} generated when the central node updates the machine learning model for one time in the centralized learning training method, the total quantity T_{CL} of times of performing model updating in the centralized learning training method, the energy consumption e^{A} of aggregating machine learning models for one time by the central node in the federated learning training method, the transmit power p^{B} of the central node, the size M of the machine learning model, the transmission rate r̅ from the central node to the distributed node, and the total quantity T_{FL} of communication cycles of the federated learning training method.

The central node may determine the second energy consumption index based on the quantity τₖ of times that the distributed node performs model updating in each communication cycle in the federated learning training method, the energy consumption eₖ^{l} generated when the distributed node updates the local machine learning model for one time, the transmit power pₖ of the distributed node, the size M of the machine learning model, the quantity Dₖ of samples in the local dataset of the distributed node, the transmission rate r̅ₖ̅ from the distributed node to the central node, and the total quantity T_{FL} of communication cycles of the federated learning training method.

When all the distributed nodes use a unified training method, the first energy consumption index may indicate the total energy consumption index existing when all the distributed nodes performs model training in the centralized learning training method, and a specific computing method is shown in Formula (13); and the second energy consumption index may indicate the total energy consumption index existing when all the distributed nodes performs model training in the federated learning training method, and a specific computing method is shown in Formula (14).

When different distributed nodes use different training methods, the first energy consumption index may indicate an energy consumption index existing when the distributed node k performs model training in the centralized learning training method, and a specific computing method is shown in Formula (15); and the second energy consumption index may indicate an energy consumption index existing when the distributed node k performs model training in the federated learning training method, and a specific computing method is shown in Formula (16).

### II. Only the Computing Energy Consumption is Considered.

For example, the central node may determine the first energy consumption index based on the electric energy use efficiency coefficient γ of the central node, the energy consumption e^{l} generated when the central node updates the machine learning model for one time in the centralized learning training method, the total quantity T_{CL} times of performing model updating in the centralized learning training method, the energy consumption e^{A} of aggregating machine learning models for one time by the central node in the federated learning training method, and the total quantity T_{FL} of communication cycles of the federated learning training method.

The central node may determine the second energy consumption index based on the quantity τₖ of times that the distributed node performs model updating in each communication cycle in the federated learning training method, the energy consumption eₖ^{l} generated when the distributed node updates the local machine learning model for one time, and the total quantity T_{FL} of communication cycles of the federated learning training method.

When all the distributed nodes use a unified training method, the first energy consumption index may indicate the total energy consumption index existing when all the distributed nodes performs model training in the centralized learning training method, and a specific computing method is shown in Formula (17); and the second energy consumption index may indicate the total energy consumption index existing when all the distributed nodes performs model training in the federated learning training method, and a specific computing method is shown in Formula (18).

$$G ( γ , {e}^{l} , {T}_{CL} , {e}^{A} , {T}_{FL} ) = γ ( {e}^{l} {T}_{CL} - {e}^{A} {T}_{FL} ) \qquad ( 17 )$$

$$F ( {τ}_{k} , {e}_{k}^{l} , {T}_{FL} ) = {T}_{FL} {\sum }_{k = 1}^{K} {τ}_{k} {e}_{k}^{l} \qquad ( 18 )$$

When different distributed nodes use different training methods, the first energy consumption index may indicate an energy consumption index existing when the distributed node k performs model training in the centralized learning training method, and a specific computing method is shown in Formula (19); and the second energy consumption index may indicate an energy consumption index existing when the distributed node k performs model training in the federated learning training method, and a specific computing method is shown in Formula (20).

$$g ( γ , {e}^{l} , {T}_{CL} , {e}^{A} , {T}_{FL} ) = \frac{γ}{K} ( {e}^{l} \frac{{T}_{CL}}{{T}_{FL}} - {e}^{A} ) \qquad ( 19 )$$

$${f}_{k} ( {τ}_{k} , {e}_{k}^{l} ) = {τ}_{k} {e}_{k}^{l} \qquad ( 20 )$$

### III. Only the Transmission Energy Consumption is Considered.

For example, the central node may determine the first energy consumption index based on the electric energy use efficiency coefficient γ of the central node, the transmit power p^{B} of the central node, the size M of the machine learning model, and the transmission rate r̅ from the central node to the distributed node.

The central node may determine the second energy consumption index based on the transmit power pₖ of the distributed node, the size M of the machine learning model, the quantity Dₖ of samples in the local dataset of the distributed node, the transmission rate r̅ₖ from the distributed node to the central node, and the total quantity T_{FL} of communication cycles of the federated learning training method.

When all the distributed nodes use a unified training method, the first energy consumption index may indicate the total energy consumption index existing when all the distributed nodes performs model training in the centralized learning training method, and a specific computing method is shown in Formula (21); and the second energy consumption index may indicate the total energy consumption index existing when all the distributed nodes performs model training in the federated learning training method, and a specific computing method is shown in Formula (22).

$$G ( γ , {p}^{B} , M , \overline{r} ) = γ {p}^{B} \frac{M}{\overline{r}} \qquad ( 21 )$$

$$F ( {p}_{k} , M , {D}_{k} , {\overline{r}}_{k} , {T}_{FL} ) = {\sum }_{k = 1}^{K} {p}_{k} \frac{M - \frac{{D}_{k}}{{T}_{FL}}}{{\overline{r}}_{k}} \qquad ( 22 )$$

When different distributed nodes use different training methods, the first energy consumption index may indicate an energy consumption index existing when the distributed node k performs model training in the centralized learning training method, and a specific computing method is shown in Formula (23); and the second energy consumption index may indicate an energy consumption index existing when the distributed node k performs model training in the federated learning training method, and a specific computing method is shown in Formula (24).

$$g ( γ , {p}^{B} , M , \overline{r} ) = \frac{γ {p}^{B} M}{K \overline{r}} \qquad ( 23 )$$

$${f}_{k} ( {p}_{k} , M , {D}_{k} , \overline{{r}_{k}} , {T}_{FL} ) = {p}_{k} \frac{M - \frac{{D}_{k}}{{T}_{FL}}}{{\overline{r}}_{k}} \qquad ( 24 )$$

If all distributed nodes that access the central node use a unified training method, when G≥F, it is determined that all the distributed nodes that access the central node train the machine learning model in the federated learning training method, that is, it is determined that the target training method is the federated learning training method; or when G<F, it is determined that all the distributed nodes that access the central node train the machine learning model in the centralized learning training method, that is, it is determined that the target training method is the centralized learning training method. A training method with a low energy consumption index is selected as a target training method for all distributed nodes that access the central node, to reduce energy consumption caused in a process of training the machine learning model. When G=F, the machine learning model is trained in the federated learning training method, because privacy disclosure caused when data is intercepted by a third party in a data transmission process may be avoided in the federated learning training method, a capability of protecting privacy of the distributed node in the federated learning training method is better than that in the distributed learning training method.

If different distributed nodes use different training methods, when g≥fₖ, it is determined that the distributed node k trains the machine learning model in the federated learning training method; or when g<fₖ, it is determined that the distributed node k trains the machine learning model in the centralized learning training method. A training method with a low energy consumption index is a target training method for the distributed node k, to reduce energy consumption caused in a process of training the machine learning model. When g=fₖ, the machine learning model is trained in the federated learning training method, so that privacy disclosure caused when data is intercepted by a third party in a data transmission process may be avoided.

It should be understood that, when G=F or when g=fₖ, the machine learning model may also be trained in the centralized learning training method. This is not specifically limited in this application.

After determining the target training method, the central node may send the first message to the distributed node. The first message includes the information about the target training method. When it is determined that the target training method is the federated learning training method, the first message may include information about the federated learning training method; or when it is determined that the target training method is the centralized learning training method, the first message may include information about the centralized learning training method. The central node may send DCI to the distributed node to indicate the target training method for the distributed node, or the central node may indicate the target training method for the distributed node based on broadcast information. For example, a 1-bit training method indicator bit is added to the DCI. When the indicator bit is “0”, the distributed node may be indicated to train the machine learning model in the centralized learning training method; or when the indicator bit is “1”, the distributed node may be indicated to train the machine learning model in the federated learning training method. For another example, a 1-bit training method indicator bit may be added to the broadcast information. When the indicator bit is “0”, the distributed node that accesses the central node may be indicated to train the machine learning model in the centralized learning training method; or when the indicator bit is “1”, the distributed node that accesses the central node may be indicated to train the machine learning model in the federated learning training method.

In the technical solutions provided in this embodiment of this application, the central node may determine, based on the first parameter set sent by the distributed node, the first energy consumption index of training the machine learning model in the first training method and the second energy consumption index of training the machine learning model in the second training method, and determines the target training method for the distributed node based on the first energy consumption index and the second energy consumption index; and the central node sends the information about the target training method for the distributed node to the distributed node based on the first message, so that the distributed node can train the machine learning model based on the target training method indicated by the central node. The target training method determined by the central node is a training method in which low energy consumption is generated in a model training process, which can reduce energy consumption of training the machine learning model.

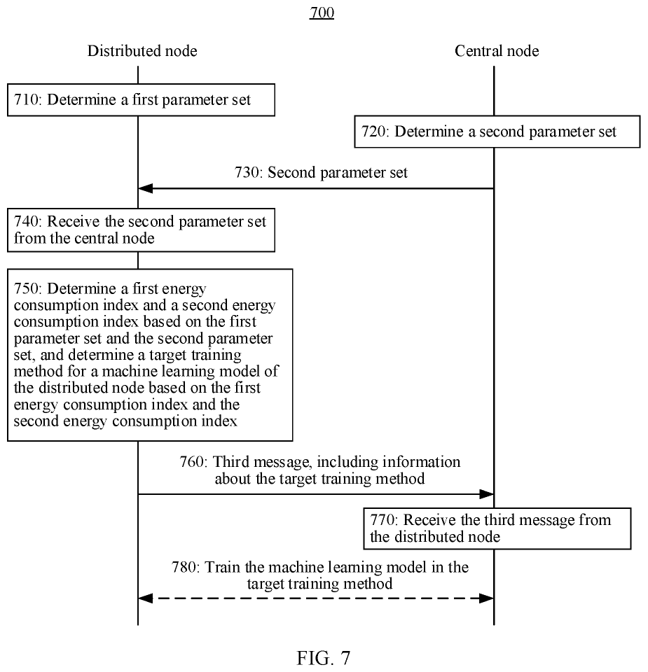

Optionally, each distributed node may independently determine a target training method for a machine learning model of the distributed node. FIG. 7 is a schematic interaction flowchart of another machine learning model training method 700 according to an embodiment of this application.
710: A distributed node determines a first parameter set, which may be understood as that a plurality of distributed nodes determine respective first parameter sets. The first parameter set is used to determine a target training method for a machine learning model of the distributed node, and the target training method may be a first training method or a second training method. Optionally, the first training method includes a centralized learning training method, the second training method includes a federated learning training method, and the second training method may further include a split learning training method, a federated distillation training method, or another training method. A parameter in the first parameter set is described above. Details are not described herein again. 710 may be performed after 740.
720: A central node determines a second parameter set, where the second parameter set is used to determine the target training method for the machine learning model of the distributed node. A parameter in the second parameter set is described above. Details are not described herein again.
730: The central node sends the second parameter set to the distributed node, which may be understood as that the central node separately sends the second parameter set to the plurality of distributed nodes.
740: The distributed node receives the second parameter set from the central node.
750: The distributed node determines a first energy consumption index and a second energy consumption index based on the parameter in the first parameter set and the parameter in the second parameter set, where the first energy consumption index indicates an energy consumption level of the first training method for the machine learning model, and the second energy consumption index indicates an energy consumption level of the second training method for the machine learning model. The second parameter set is determined by the central node, and the parameter in the second parameter set is described above. Details are not described herein again. The distributed node determines the target training method for the machine learning model of the distributed node based on the first energy consumption index and the second energy consumption index. Optionally, if the first energy consumption index is greater than or equal to the second energy consumption index, the distributed node may determine that the target training method is the second training method; or if the first energy consumption index is less than the second energy consumption index, the distributed node may determine that the target training method is the first training method. Optionally, if the first energy consumption index is greater than the second energy consumption index, the distributed node may determine that the target training method is the second training method; or if the first energy consumption index is less than or equal to the second energy consumption index, the distributed node may determine that the target training method is the first training method. It should be understood that when the first energy consumption index is equal to the second energy consumption index, the target training method may be the first training method, or may be the second training method. For a specific manner in which the distributed node determines the first energy consumption index and the second energy consumption index based on the parameter in the first parameter set and the parameter in the second parameter set, refer to the foregoing energy consumption index computing formulas used when different distributed nodes are allowed to use different training methods, for example, Formula (15) and Formula (16), Formula (19) and Formula (20), and Formula (23) and Formula (24).

For example, the distributed node may determine the first energy consumption index and the second energy consumption index based only on the parameter in the first parameter set, and determine the target training method for the distributed node based on the first energy consumption index and the second energy consumption index.
760: The distributed node sends a third message to the central node, where the third message includes information about the target training method. The third message indicates, to the central node, a specific training method in which each of different distributed nodes trains the machine learning model. The distributed node may indicate the target training method for the distributed node to the central node by using a message or signaling. For example, the distributed node may send uplink control information (uplink control information, UCI) to the central node to indicate the target training method for the distributed node. A 1-bit training method indicator bit may be added to the UCI. When the indicator bit is “0”, the distributed node may be indicated to train the machine learning model in the first training method; or when the indicator bit is “1”, the distributed node may be indicated to train the machine learning model in the second training method.
770: The central node receives the third message from the distributed node, which may be understood as that the central node receives a plurality of third messages from the plurality of distributed nodes; and the central node learns of the target training method for the distributed node based on the third message.
780: The distributed node and the central node train the machine learning model in the target training method.

Optionally, before 710, the central node may further indicate, by sending control signaling, the plurality of distributed nodes to start a process of selecting a machine learning model training method. If some distributed nodes that access the central node support only one training method, the distributed nodes do not need to select a training method, and the distributed nodes may directly indicate, to the central node, a machine learning model training method supported by the distributed nodes.

The method may be applied to a case in which different distributed nodes use different training methods. Each distributed node may determine a target training method for the distributed node by computing an energy consumption index of performing model training in a centralized learning training method and an energy consumption index of performing model training in a federated learning training method.

The method may be further applied to a case in which all distributed nodes use a unified training method. In this case, before step 780, after all the distributed nodes report respective target training methods, the central node may determine a unified training method in an entire system based on reporting situations of all the distributed nodes. For example, when a large quantity of distributed nodes select the centralized learning training method, the central node determines that the unified training method in the entire system is the centralized learning training method; or when a large quantity of distributed nodes select the federated learning training method, the central node determines that the unified training method in the entire system is the federated learning training method. Before step 780, the central node may send a fourth message to all distributed nodes that access the central node. The fourth message indicates, to all the distributed nodes, a unified training method for training the machine learning model Optionally, the central node may indicate, by using a message or signaling, the unified training method to all the distributed nodes that access the central node. The signaling may be DCI, or may be broadcast signaling.

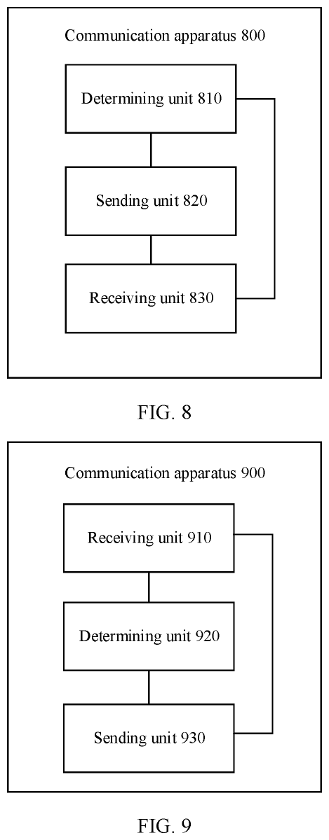

An embodiment of this application provides a communication apparatus. FIG. 8 is a schematic block diagram of a communication apparatus 800 according to an embodiment of this application. The apparatus may be used in a distributed node in this embodiment of this application. The communication apparatus 800 includes:
a determining unit 810, configured to determine a first parameter set;
a sending unit 820, configured to send a first parameter set to a central node, where the first parameter set is used to determine a target training method for a machine learning model of the distributed node, and the target training method includes a first training method or a second training method; and
a receiving unit 830, configured to receive a first message from the central node, where the first message includes information about the target training method.

Optionally, the first parameter set includes energy consumption generated when the distributed node updates a local machine learning model for one time.

Optionally, the first parameter set further includes at least one of the following parameters: a quantity of samples in a local dataset of the distributed node, a quantity of times that the distributed node performs model updating in each communication cycle, a transmit power of the distributed node, a transmission rate from the central node to the distributed node, or information about a channel from the central node to the distributed node.

Optionally, the first training method includes a centralized learning training method, and the second training method includes a federated learning training method.

Optionally, the sending unit 820 is further configured to send a second message to the central node. The second message is used to feed back that the distributed node supports the first training method and the second training method.

An embodiment of this application provides a communication apparatus. FIG. 9 is a schematic block diagram of a communication apparatus 900 according to an embodiment of this application. The apparatus may be used in a central node in this embodiment of this application. The communication apparatus 900 includes:
a receiving unit 910, configured to receive a first parameter set from a distributed node, where the first parameter set is used to determine a target training method for a machine learning model of the distributed node, and the target training method includes a first training method or a second training method; and
a determining unit 920, configured to determine the target training method for the machine learning model of the distributed node based on the first parameter set; and
a sending unit 930, configured to send a first message to the distributed node, where the first message includes information about the target training method.

Optionally, the first parameter set includes energy consumption generated when the distributed node updates a local machine learning model for one time.

Optionally, the first parameter set further includes at least one of the following parameters: a quantity of samples in a local dataset of the distributed node, a quantity of times that the distributed node performs model updating in each communication cycle in the second training method, a transmit power of the distributed node, a transmission rate from the central node to the distributed node, or information about a channel from the central node to the distributed node.

Optionally, the determining unit 920 is specifically configured to:
determine a first energy consumption index and a second energy consumption index based on the first parameter set, where the first energy consumption index indicates an energy consumption level of the first training method for the machine learning model, and the second energy consumption index indicates an energy consumption level of the second training method for the machine learning model; and
determine the target training method for the machine learning model of the distributed node based on the first energy consumption index and the second energy consumption index.

Optionally, the determining unit 920 is specifically configured to:
determine a first energy consumption index and a second energy consumption index based on the first parameter set and a second parameter set, where the second parameter set is determined by the central node, the first energy consumption index indicates an energy consumption level of the first training method for the machine learning model, and the second energy consumption index indicates an energy consumption level of the second training method for the machine learning model; and
determine the target training method for the machine learning model of the distributed node based on the first energy consumption index and the second energy consumption index.

Optionally, the determining unit 920 is specifically configured to: if the first energy consumption index is greater than or equal to the second energy consumption index, determine that the target training method is the second training method; or if the first energy consumption index is less than the second energy consumption index, determine that the target training method is the first training method.

Optionally, the second parameter set includes at least one of the following parameters: a size of the machine learning model, energy consumption generated when the central node updates the machine learning model for one time in the first training method, energy consumption generated when the central node aggregates machine learning models for one time in the second training method, an electric energy use efficiency coefficient of the central node, a transmit power of the central node, a total quantity of communication cycles of the second training method, a total quantity of times of performing model updating in the first training method, a transmission rate from the distributed node to the central node, or information about a channel from the distributed node to the central node.

Optionally, the determining unit 920 is specifically configured to:
determine the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, a transmit power of the central node, a size of the machine learning model, a transmission rate from the central node to the distributed node, and a total quantity of communication cycles of the second training method; and/or
determine the second energy consumption index based on a quantity of times that the distributed node performs model updating in each communication cycle in the second training method, energy consumption generated when the distributed node updates a local machine learning model for one time, a transmit power of the distributed node, a size of the machine learning model, a quantity of samples in a local dataset of the distributed node, a transmission rate from the distributed node to the central node, and a total quantity of communication cycles of the second training method.

Optionally, the determining unit 920 is specifically configured to:
determine the first energy consumption index based on an electric energy use efficiency coefficient of the central node, energy consumption generated when the central node updates the machine learning model for one time in the first training method, a total quantity of times of performing model updating in the first training method, energy consumption generated when the central node aggregates machine learning models for one time in the second training method, and a total quantity of communication cycles of the second training method; and/or
determine the second energy consumption index based on a quantity of times that the distributed node performs model updating in each communication cycle in the second training method, energy consumption generated when the distributed node updates a local machine learning model for one time, and a total quantity of communication cycles of the second training method.

Optionally, the determining unit 920 is specifically configured to:
determine the first energy consumption index based on an electric energy use efficiency coefficient of the central node, a transmit power of the central node, a size of the machine learning model, and a transmission rate from the central node to the distributed node; and/or
determine the second energy consumption index based on a transmit power of the distributed node, a size of the machine learning model, a quantity of samples in a local dataset of the distributed node, a transmission rate from the distributed node to the central node, and a total quantity of communication cycles of the second training method.

Optionally, the first training method includes a centralized learning training method, and the second training method includes a federated learning training method.

Optionally, the receiving unit 910 is further configured to receive a second message from the distributed node. The second message is used to feed back that the distributed node supports the first training method and the second training method.

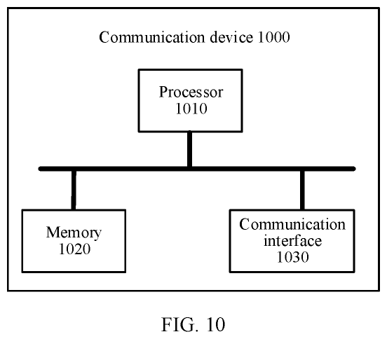

An embodiment of this application provides a communication device 1000. FIG. 10 is a schematic block diagram of a communication device 1000 according to an embodiment of this application.

The communication device 1000 includes a processor 1010, a memory 1020, and a communication interface 1030.

The memory 1020 is configured to store executable instructions.

The processor 1010 is coupled to the memory 1020 through the communication interface 1030. The processor 1010 is configured to invoke and run the executable instructions in the memory 1020, to implement the method in this embodiment of this application. The communication device may be a terminal device (a distributed node) or a network device (a central node) in this embodiment of this application.

The processor 1010 may be an integrated circuit chip and has a signal processing capability. In an implementation process, steps in the method embodiments may be implemented by using a hardware integrated logical circuit in the processor, or by using instructions in a form of software. The processor may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, or a discrete hardware component. The processor may implement or perform the methods, the steps, and logical block diagrams that are disclosed in embodiments of this application. The general-purpose processor may be a microprocessor, or the processor may be any conventional processor, or the like. Steps of the methods disclosed with reference to embodiments of this application may be directly executed and completed by a hardware decoding processor, or may be executed and completed by a combination of hardware and software modules in the decoding processor. A software module may be located in a mature storage medium in the art such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

Optionally, an embodiment of this application further provides a communication device. The communication device includes an input/output interface and a logic circuit. The input/output interface is configured to obtain input information and/or output information. The logic circuit is configured to: perform the method in any one of the method embodiments, and perform processing and/or generate output information based on the input information.

An embodiment of this application further provides a computer-readable storage medium. The computer-readable storage medium stores a computer program used to implement the method in the method embodiments. When the computer program is run on a computer, the computer is enabled to implement the method in the method embodiments.

An embodiment of this application further provides a computer program product. The computer program product includes computer program code. When the computer program code runs on a computer, the method in the method embodiment is performed.

An embodiment of this application further provides a chip, including a processor. The processor is connected to a memory, the memory is configured to store a computer program, and the processor is configured to execute the computer program stored in the memory, so that the chip performs the method in the method embodiments.

It should be understood that, in embodiments of this application, numbers “first”, “second”, and the like are merely used to distinguish between different objects, for example, to distinguish between different energy consumption indexes, and do not constitute a limitation on the scope of embodiments of this application. Embodiments of this application are not limited thereto.

In addition, the term “and/or” in this application describes only an association relationship for describing associated objects and represents that three relationships may exist. For example, A and/or B may represent the following three cases: Only A exists, both A and B exist, and only B exists. In addition, the character “/” in this specification usually represents an “or” relationship between associated objects. In this application, the term “at least one” may represent “one” or “two or more”. For example, at least one of A, B, and C may represent the following seventh cases: Only A exists, only B exists, only C exists, both A and B exist, both A and C exist, and both C and B exist, and A, B, C all exist.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art may clearly learn that, for the purpose of convenient and brief description, for a specific working process of the system, apparatus, and unit, refer to a corresponding process in the method embodiments. Details are not described herein again.

In the several embodiments provided in this application, it should be understood that the disclosed system, apparatus, and method may be implemented in another manner. For example, the described apparatus embodiments are merely examples. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separated, and parts displayed as units may or may not be physical units, that is, may be located at one place, or may be distributed on a plurality of network units. Some or all of the units may be selected based on an actual requirement, to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code such as a USB flash drive, a removable hard disk, a read-only memory (read-only memory, ROM), a random access memory (random access memory, RAM), a magnetic disk, or an optical disc.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A machine learning model training method, comprising:
sending, by a distributed node, a first parameter set to a central node, wherein the first parameter set is used to determine a target training method for a machine learning model of the distributed node, and the target training method comprises a first training method or a second training method; and
receiving, by the distributed node, a first message from the central node, wherein the first message comprises information about the target training method.

2. The machine learning model training method according to claim 1, wherein the first parameter set comprises:
energy consumption generated when the distributed node updates a local machine learning model for one time.

3. The machine learning model training method according to claim 2, wherein the first parameter set further comprises at least one of the following parameters:
a quantity of samples in a local dataset of the distributed node, a quantity of times that the distributed node performs model updating in each communication cycle, a transmit power of the distributed node, a transmission rate from the central node to the distributed node, or information about a channel from the central node to the distributed node.

4. The machine learning model training method according to claim 1, wherein
the first training method comprises a centralized learning training method, and the second training method comprises a federated learning training method.

5. The machine learning model training method according to claim 1, further comprising:
sending, by the distributed node, a second message to the central node, wherein the second message is used to feed back that the distributed node supports the first training method and the second training method.

6. A machine learning model training method, comprising:
receiving, by a central node, a first parameter set from a distributed node, wherein the first parameter set is used to determine a target training method for a machine learning model of the distributed node, and the target training method comprises a first training method or a second training method; and
sending, by the central node, a first message to the distributed node, wherein the first message comprises information about the target training method.

7. The machine learning model training method according to claim 6, wherein the first parameter set comprises:
energy consumption generated when the distributed node updates a local machine learning model for one time.

8. The machine learning model training method according to claim 7, wherein the first parameter set further comprises at least one of the following parameters:
a quantity of samples in a local dataset of the distributed node, a quantity of times that the distributed node performs model updating in each communication cycle in the second training method, a transmit power of the distributed node, a transmission rate from the central node to the distributed node, or information about a channel from the central node to the distributed node.

9. The machine learning model training method according to claim 6, wherein before the sending, by the central node, a first message to the distributed node, the machine learning model training method further comprises:
determining, by the central node, a first energy consumption index and a second energy consumption index based on the first parameter set, wherein the first energy consumption index indicates an energy consumption level of the first training method for the machine learning model, and the second energy consumption index indicates an energy consumption level of the second training method for the machine learning model; and
determining, by the central node, the target training method for the machine learning model of the distributed node based on the first energy consumption index and the second energy consumption index.

10. The machine learning model training method according to claim 6, wherein before the sending, by the central node, a first message to the distributed node, the machine learning model training method further comprises:
determining, by the central node, a first energy consumption index and a second energy consumption index based on the first parameter set and a second parameter set, wherein the second parameter set is determined by the central node, the first energy consumption index indicates an energy consumption level of the first training method for the machine learning model, and the second energy consumption index indicates an energy consumption level of the second training method for the machine learning model; and
determining, by the central node, the target training method for the machine learning model of the distributed node based on the first energy consumption index and the second energy consumption index.

11. The machine learning model training method according to claim 9, wherein the determining, by the central node, the target training method for the machine learning model of the distributed node based on the first energy consumption index and the second energy consumption index comprises:
if the first energy consumption index is greater than or equal to the second energy consumption index, determining, by the central node, that the target training method is the second training method; or
if the first energy consumption index is less than the second energy consumption index, determining, by the central node, that the target training method is the first training method.

12. The machine learning model training method according to claim 10, wherein the second parameter set comprises at least one of the following parameters:
a size of the machine learning model, energy consumption generated when the central node updates the machine learning model for one time in the first training method, energy consumption generated when the central node aggregates machine learning models for one time in the second training method, an electric energy use efficiency coefficient of the central node, a transmit power of the central node, a total quantity of communication cycles of the second training method, a total quantity of times of performing model updating in the first training method, a transmission rate from the distributed node to the central node, or information about a channel from the distributed node to the central node.

13. The machine learning model training method according to claim 6, wherein
the first training method comprises a centralized learning training method, and the second training method comprises a federated learning training method.

14. The machine learning model training method according to claim 6, wherein the machine learning model training method further comprises:
receiving, by the central node, a second message from the distributed node, wherein the second message is used to feed back that the distributed node supports the first training method and the second training method.

15. A communication apparatus, comprising at least one processor, and one or more memories coupled to the at least one processor and storing programming instructions for execution by the at least one processor to perform operations comprising:
sending a first parameter set to a central node, wherein the first parameter set is used to determine a target training method for a machine learning model of a distributed node, and the target training method comprises a first training method or a second training method; and
receiving a first message from the central node, wherein the first message comprises information about the target training method.

16. The apparatus according to claim 15, wherein the first parameter set comprises:
energy consumption generated when the distributed node updates a local machine learning model for one time.

17. The apparatus according to claim 15, wherein the first parameter set further comprises at least one of the following parameters:
a quantity of samples in a local dataset of the distributed node, a quantity of times that the distributed node performs model updating in each communication cycle, a transmit power of the distributed node, a transmission rate from the central node to the distributed node, or information about a channel from the central node to the distributed node.

18. The apparatus according to claim 15, wherein
the first training method comprises a centralized learning training method, and the second training method comprises a federated learning training method.

19. The apparatus according to claim 15, wherein the operations further comprise:
sending a second message to the central node, wherein the second message is used to feed back that the distributed node supports the first training method and the second training method.
